(19) United States
(12) Patent Application Publication
(10) Pub. No.: US 2015/0050831 A1
(43) Pub. Date: Feb. 19, 2015

(54) ELECTRIC WIRE CONNECTING STRUCTURE AND ELECTRICAL JUNCTION BOX

(71) Applicant: YAZAKI CORPORATION, Tokyo (JP)

(72) Inventors: Yasuhiro TANAKA, Kakegawa-shi (JP); Naoto TAKASHIMA, Kakegawa-shi (JP); Kouichirou TOU, Kakegawa-shi (JP); Junya YAMAMOTO, Kakegawa-shi (JP); Yoshiyuki ISHIHARA, Toyota-shi (JP); Takanori KAWAI, Toyota-shi (JP)

(73) Assignee: YAZAKI CORPORATION, Tokyo (JP)

(21) Appl. No.: 14/528,348

(22) Filed: Oct. 30, 2014

Related U.S. Application Data
(63) Continuation of application No. PCT/JP2013/063231, filed on May 2, 2013.

(30) Foreign Application Priority Data
May 2, 2012 (JP) 2012-105029

(51) Int. Cl. H01R 4/20; H01R 9/24

(52) U.S. Cl. CPC H01R 4/20; H01R 9/24
USPC 439/502

(57) ABSTRACT

An electric wire connecting structure includes a connector, a pair of electrical wires, a pair of crimped terminals, and a resin block to which the pair of crimped terminals are attached in a state that the pair of electric wires are curved. Each of the pair of crimped terminals includes a terminal part, a crimped part, and a conductor that connects the terminal part and the crimped part, the conductor is located between the terminal part and the crimped part. The crimped part crimps the core wire of the electric wire and the electric wire is extended toward the conductor. The pair of electric wires are wired in a crossed state between the connector and the pair of crimped terminals.

### CROSS REFERENCE TO RELATED APPLICATIONS

This application is a continuation of PCT application No. PCT/JP2013/063231, which was filed on May 2, 2013 based on Japanese Patent Application (No. 2012-105029) filed on May 2, 2012, the contents of which are incorporated herein by reference.

### BACKGROUND OF THE INVENTION

1. Field of the Invention

The present disclosure relates to an electric wire connecting structure using crimped terminals, and an electrical junction box, and particularly to an electrical junction box which is mounted in a movable object such as an electric vehicle and which accommodates electrical components.

2. Description of the Related Art

In an electric vehicle which is driven by using an electric motor, for example, an electrical junction box which accommodates electrical components which connect a power supply and a plurality of loads is loaded. This electrical junction box accommodates an insulative terminal block which holds conductors such as bus bars in a case, and a plurality of electric wires drawn into the case are connected to the bus bars through crimped terminals, respectively. The case of this kind of electrical junction box is formed of metal to make the shielding property (For example, refer to JP-A-2012-10590).

### SUMMARY OF THE INVENTION

In such an electrical junction box, the electric wires or the like drawn into the case from the outside are arranged in the case into an approximately straight shape, but most of the electric wires that are connected between components in the case are connected in a curved state by having an extra length (surplus length) to some extent.

However, because high voltage cables or the like are usually used in this kind of electric wires, and the reaction force of the electric wires when the electric wires are curved is relatively large, a burden in the attaching operation while the electric wires are curved becomes large. In particular, with respect to the length of the electric wires (full length of the electric wires), because the shortest length of the electric wires in production is prescribed beforehand, for example, if the distance between components to which the electric wires are connected is shorter than the shortest length of the electric wires, such short electric wires must be connected by being forcibly curved, and in this case, a large reaction force from the electric wires is received.

When the electric wires are curved forcibly to be connected, a space where the electric wires are handled in the case must be secured, and there is a problem that the design flexibility is limited.

The object of the present disclosure is to reduce the burden in the operation of attaching the electric wires, and to raise the design flexibility by reducing the space where the electric wires are handled.

The present disclosure has been made in the above circumstances in the art, and an object of the present disclosure is to provide a crimped terminal comprising:

a terminal part to which an external circuit is connected;

a crimped part to which a core wire of an electric wire is crimped; and

a conductor that connects the terminal part and the crimped part, the conductor being located between the terminal part and the crimped part,

wherein the crimped part is configured to crimp the core wire of the electric wire and the electric wire is extended toward the conductor.

For example, the terminal part, the crimped part and the conductor are integrally formed by a single conductive plate.

For example, the terminal part is bent in a direction substantially perpendicular to an extending direction of the conductor.

According to these aspect, because the terminal part of the crimped terminal can be located to the rear of the electric wire relative to the end portion of the electric wire (the crimped portion), the electric wire can be connected with the external circuit in a state that the electric wire is prolonged to some extent, and the burden in the operation of attaching the electric wire can be reduced. Because the space where the electric wire is handled is reduced by reducing the curving of the electric wire, the design flexibility can be raised.

Here, the present disclosure also provides an electric wire connecting structure comprising:

a connector;

a pair of electrical wires, one ends of which are connected to the connector;

a pair of crimped terminals that are respectively connected to the other ends of the pair of electric wires; and

a resin block to which the pair of crimped terminals are attached in a state that the pair of electric wires are curved,

wherein each of the pair of crimped terminals including:
a terminal part to which an external circuit is connected;
a crimped part to which a core wire of the electric wire is crimped; and
a conductor that connects the terminal part and the crimped part, the conductor being located between the terminal part and the crimped part;

wherein the crimped part is configured to crimp the core wire of the electric wire and the electric wire is extended toward the conductor; and

wherein the pair of electric wires are wired in a crossed state between the connector and the pair of crimped terminals.

By crossing the electric wires in this way, without adding an excessive force on the electric wires, the electric wires can be bundled up and the space where the electric wires are handled can be reduced.

For example, the pair of electric wires are wired in a space between the pair of crimped terminals.

According to this aspect, because the electric wires are wired to be mutually crossed between the crimped terminals, a gap that increases in accordance with the distance from the crimped parts is formed between the electric wires and the conductors. Therefore, the wornness of the electric wires due to the vibration when the electric wires contact with the conductors can be inhibited.

For example, in each of the pair of crimped terminals, the terminal part is bent in a direction substantially perpendicular to an extending direction of the conductor, and the pair of crimped terminals are so formed that angles that imaginary axes of the electric wires which are crimped to the crimped parts make with imaginary planes including the terminal parts are different from each other.

According to this aspect, because angles that the pair of electric wires are respectively wired from the connector to the resin block can be made different from each other, the contact of the electric wires when the electric wires cross can be prevented, and the space where the electric wires are handled can be further reduced. Because the load applied on the electric wires can be reduced, the connected state of the electric wires can be stably maintained.

Here, the present disclosure also provides an electrical junction box for connecting a power supply and a load, comprising:

a terminal block that holds a bus bar to which a pair of electric wires connected to the power supply and an electric wire connected to the load are commonly connected;

a resin block that is attached onto the terminal block; and

a conductive case that accommodates the terminal block,

wherein one ends of the pair of electric wires connected to the power supply are connected to a connector arranged at a bottom part of the conductive case, and the other ends of the pair of electric wires connected to the power supply are held in the resin block through the pair of crimped terminals;

wherein each of the pair of crimped terminals including:
a terminal part to which an external circuit is connected;
a crimped part to which a core wire of the electric wire is crimped; and
a conductor that connects the terminal part and the crimped part, the conductor being located between the terminal part and the crimped part;

wherein the crimped part is configured to crimp the core wire of the electric wire and the electric wire is extended toward the conductor;

wherein the resin block is so formed that when the resin block is attached onto the terminal block, the terminal parts of the pair of crimped terminals are arranged at positions where the terminal parts are connected to the bus bar; and

wherein the pair of electric wires are wired in a crossed state between the connector and the pair of crimped terminals.

According to this aspect, because in the limited space in the case, the pair of electric wires connected to the power supply side can be connected without being forcibly curved, the operation of attaching the electric wires can be performed efficiently. Because the space where the electric wires are handled in the case can be reduced by reducing the curving of the electric wires, products which are not kept in the traditional electric wire course can be designed and the design flexibility can be raised.

For example, the resin block has accommodating rooms which accommodate the crimped parts of the pair of crimped terminals respectively. Therefore, the space where the electric wires are handled in the case can be further reduced.

For example, an insulative cover member which surrounds the pair of crimped terminals held in the resin block is attached to the resin block. Therefore, the crimped terminals held by the resin block can easily covered in a space-saving way, and a short circuit of the crimped terminals and the case can be prevented surely.

According to the present disclosure, while the burden in the operation of attaching the electric wires is reduced, the design flexibility can be raised by reducing the space where the electric wires are handled.

### BRIEF DESCRIPTION OF THE DRAWINGS

FIG. 1 is an exploded perspective view in which an electrical junction box according to the present disclosure is decomposed.

FIG. 2 is a figure which shows that electrical components and electric wires accommodated in a case of FIG. 1 are connected.

FIG. 3 is a perspective view which shows the internal construction of the electrical junction box according to the present disclosure.

FIG. 4 is an exploded perspective view in which a part of the electrical components accommodated in the case of FIG. 1 is decomposed.

FIG. 5 is a top view which shows the internal construction of the electrical junction box according to the present disclosure.

FIG. 6 is a figure which shows the construction of crimped terminals held by a resin block.

### DETAILED DESCRIPTION OF THE EXEMPLARY EMBODIMENTS

Next, an embodiment of the electrical junction box of the invention will be described with reference to the figures. In this embodiment, an example is described in which crimped terminals and an electric wire connecting structure according to the present disclosure are applied to an electrical junction box which is mounted in an electric car, but the present disclosure is not limited to this example, and, for example, the crimped terminals and the electric wire connecting structure can be applied to an electrical junction box which is mounted in various kinds of movable objects such as hybrid cars.

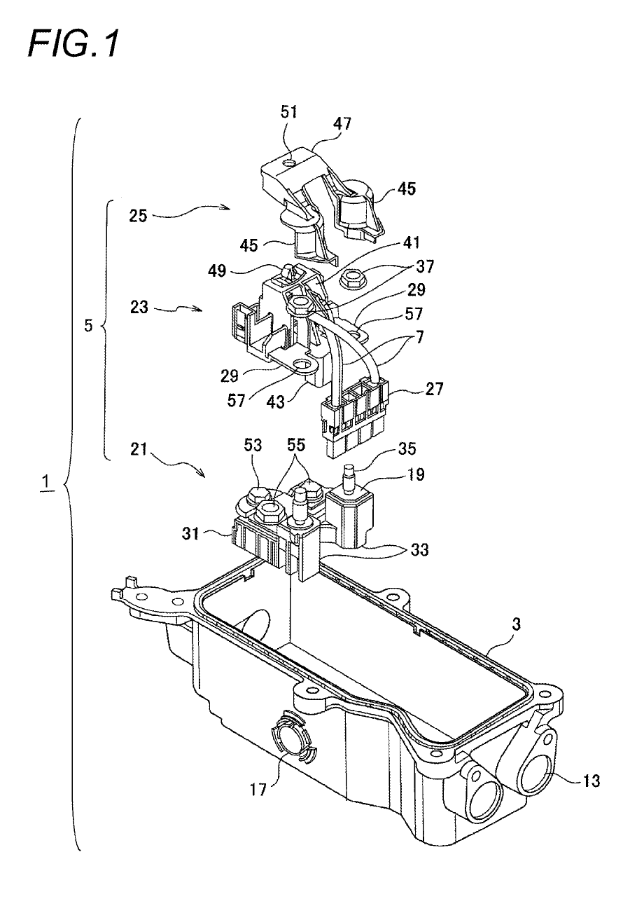

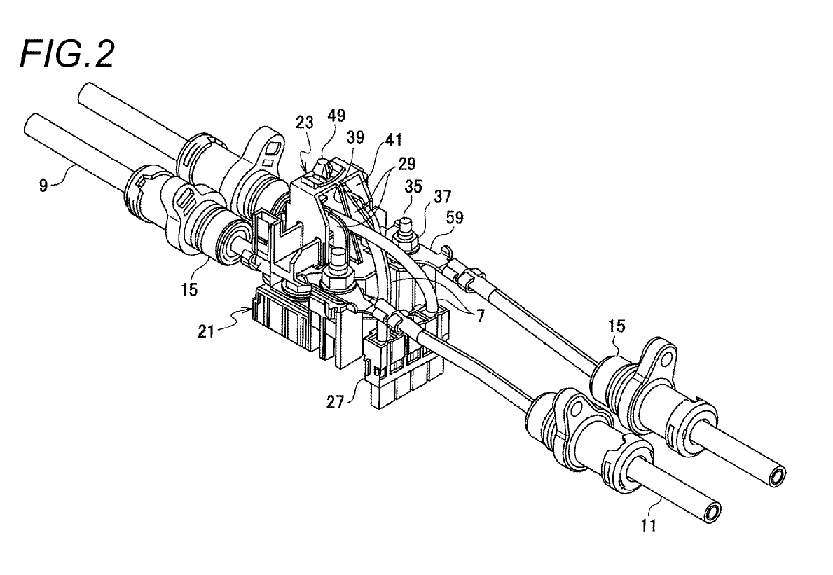

An electrical junction box 1 according to the present disclosure includes a case 3 and electrical components 5 accommodated in the case 3, as shown in FIG. 1. The electrical components 5 are adapted to connect a power supply to a plurality of loads (here, an electric motor and a battery) by connecting electric wires 7 connected to the side of the power supply, electric wires 9 (FIG. 2) connected to the side of the battery and electric wires 11 (FIG. 2) connected to the side of the electric motor to the electrical components, respectively.

The case 3 is a frame-like member whose section in a top view is formed into a rough rectangle. The case 3 has opening parts at both ends. One opening part is connected to another component (a converter or the like) not shown in the figure, and the other opening part is sealed by being covered with a cover not shown in the figure. The waterproofness of the case 3 is secured by providing packings (not shown in the figure) respectively at a part where the another component abuts against the one opening part, and at a part where the cover abuts against the other opening part of the case 3. The case 3 is formed of metal to secure the shielding performance of the electrical junction box 1.

Two side walls of the case 3, which are opposite to each other, are provided with a pair of electric wire through holes 13 through which the electric wires 9 and 11, which are respectively connected to the electrical components 5 in the case 3, are inserted, and grommets 15 (FIG. 2) which protect the electric wires 9 and 11 are fitted and installed into these electric wire through holes 13.

One side wall of the case 3 where the electric wire through holes 13 are not formed is provided with a differential pressure adjusting valve 17 from which gas is introduced into the case 3 to raise the waterproofness of the case 3. By introducing gas into the case 3 from the differential pressure adjusting valve 17, and maintaining the pressure in the case to be higher than the outside pressure, the invasion of, for example, water from the outside is prevented and high waterproofness is secured.

The electrical components 5 includes bus bars 19 to which the electric wires 7 connected to the side of the power supply, the electric wires 9 connected to the side of the battery and the electric wires 11 connected to the side of the electric motor are commonly connected, a terminal block 21 which holds the bus bars 19, a resin block 23 which is attached onto the terminal block 21, and a cover member 25 which is placed over the resin block 23. These electrical components 5 are attached to a bottom part (surfaces except the opening parts) of the case 3.

The grommets 15 are attached to the electric wires 9 connected to the battery side and the electric wires 11 connected to the electric motor side, respectively, and crimped terminals not shown in the figure are connected to one ends of these electric wires, respectively. Crimped terminals are connected to both ends of the electric wires 7 connected to the power supply side, in which crimped terminals at one ends (not shown in the figure) are connected to a connector 27, and crimped terminals 29 at the other ends are connected to the resin block 23.

The terminal block 21 is a resin molded article which has stepped supporting surfaces which support the bus bars 19, and has a roughly cuboid-formed base 31 and quadratic prism-formed columnar parts 33 which are spaced from each other for a predetermined interval and raised from the base 31. Supporting surfaces which support the bus bars 19, respectively, are formed on the top surface of the base 31 and the top surfaces of the columnar parts 33. Although not shown in the figure, metal female members which are spaced from each other are embedded in the supporting surface of the base 31. Metal columnar projections 35 are respectively raised on the supporting surfaces of the columnar parts 33, and each of the projections 35 is provided with a groove where a nut 37 to be described below is fitted.

The bus bars 19 are provided with two surfaces which abut with those supporting surfaces of the terminal block 21 by bending a metal plate into a stepped shape, and these surfaces are provided with insertion holes, respectively. In FIG. 1, it is shown that the bus bars 19 are attached to the supporting surfaces of the terminal block 21.

The resin block 23 is a resin molded article which holds a pair of the crimped terminals of the electric wires 7 connected to the power supply side, and has a terminal accommodating room 41 which accommodates the pair of crimped terminals 29 by partitioning the crimped terminals 29 with a resin wall 39 (FIG. 2), and an embedded part 43 which are embedded between columnar parts 35 of the terminal block 21. The two crimped terminals 29 held by the resin block 23 are held by the resin block 23 in a state that one end side of each of the crimped terminals 29 is accommodated in the accommodating room 41, and the other end side of each of the crimped terminals 29 protrudes beyond the terminal accommodating room 41. The resin block 23 is so adapted that when the resin block 33 is attached onto the terminal block 21, the other end sides of the crimped terminals 29 are arranged at positions where it is possible to abut with the bus bars 19.

The cover member 25 is a resin member which surrounds the resin block 23 and the terminal block 21, and particularly the crimped terminals 29 held in the resin block 23, and has two partitioning walls 45 which extend with a predetermined interval from each other to respectively partition the columnar parts 33 and the projections 35 of the terminal block 21, and a connecting part 47 which connects the these partitioning walls 45. The cover member 25 is arranged so that the connecting part 47 faces the top surface of the resin block 23, and the connecting part 47 is provided with a locking hole 51 into which a locking projection 49 which rises from the top surface of the resin block 23 is inserted.

Next, an example of assembling the electrical junction box 1 is described by using FIG. 1. First, the terminal block 21 is incorporated into the case 3, and the terminal block 21 is fastened to the bottom part of the case 3 with a bolt 53. Then, the two bus bars 19 are attached to the supporting surfaces of the terminal block 21 which is fixed to the case 3. At this time, the projections 35 of the terminal block 21 are inserted into the insertion holes at one ends of the bus bars 19, and the insertion holes at the other ends of the bus bars 19 are arranged in accordance with the screw holes of the female members.

Then, the electric wires 9 connected to the battery side and the electric wires 11 connected to the electric motor side are inserted through the electric wire through holes 13 of the case 3, respectively. When insertion holes formed in the crimped terminals of the electric wires 9 connected to the battery side are aligned with the insertion holes at the other ends of the bus bars 19, by inserting bolts 55 into the holes and making the bolts 55 to be threadedly engaged into the screw holes of the female members of the supporting surfaces, the electric wires 9 are connected to the terminal block 21.

On the other hand, among the crimped terminals which are connected to two ends of the electric wire 7 connected to the power supply side, those crimped terminals at one ends are connected to the connector 27, and those crimped terminals 29 at the other ends are connected to the resin block 23. The connector 27 is embedded in an accommodating hole of the connector 27 (not shown in the figure) formed at the bottom part of the case 3. In this state, the resin block 23 which holds the crimped terminals 29 is attached onto the terminal block 21. In particular, along the projections 35 of the terminal block 21, mounting holes 57 of the crimped terminals 29 which protrude beyond the accommodating room 41 of the resin block 23 and mounting holes formed in the crimped terminals 59 (FIG. 2) of the electric wires 11 connected to the electric motor side are overlaid sequentially, and nuts 37 are threadedly engaged with the projections 35. At this time, the embedded part 43 of the resin block 23 is embedded between the two columnar parts 33 of the terminal block 21. In this way, the electric wires 7, 9 and 11 are connected with each other through the bus bars 19 of the terminal block 21. The grommets 15 of the electric wires 9 and 11 are fitted and installed into the electric wire through holes 13, and are fixed to the case 3 with screws not shown in the figure.

The appearance of the electrical components 5 (including the electric wires) installed in the case 3 in this way is shown in FIG. 2. In FIG. 2, the case 3 is omitted.

Then, the resin block 23 is covered with the cover member 25. The cover member 25 is attached to the resin block 23 when the cover member 25 is locked by inserting the locking projection 49 of the resin block 23 into the locking hole 51 of the cover member 25. Thereby, the crimped terminals 29 which are connected to and held in the resin block 23 are covered by the cover member 25, and a short circuit with the inner wall surfaces of the cover 3 can be prevented.

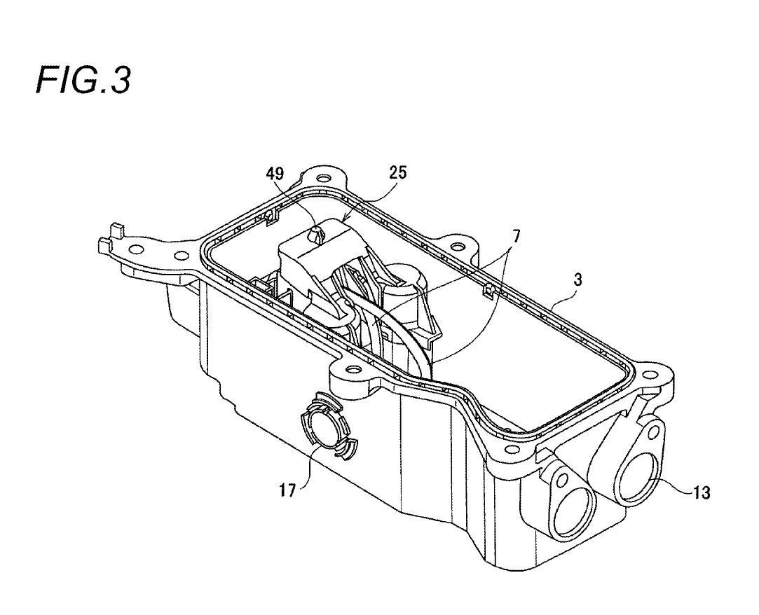

In this way, the appearance of the electrical components 5 after the cover member 25 is attached into the case 3 is shown in FIG. 3.

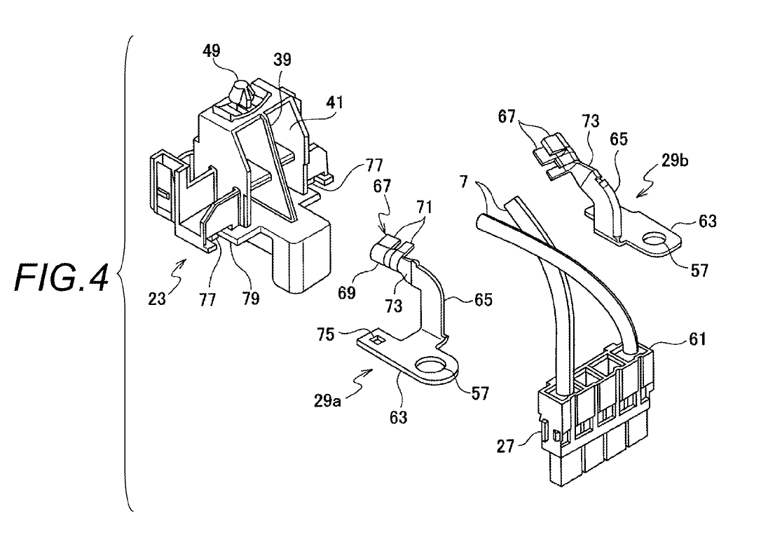

Next, a structure of connecting the electric wires 7 connected to the power supply side which becomes a characteristic feature of the invention is described by using FIGS. 4 to 6.

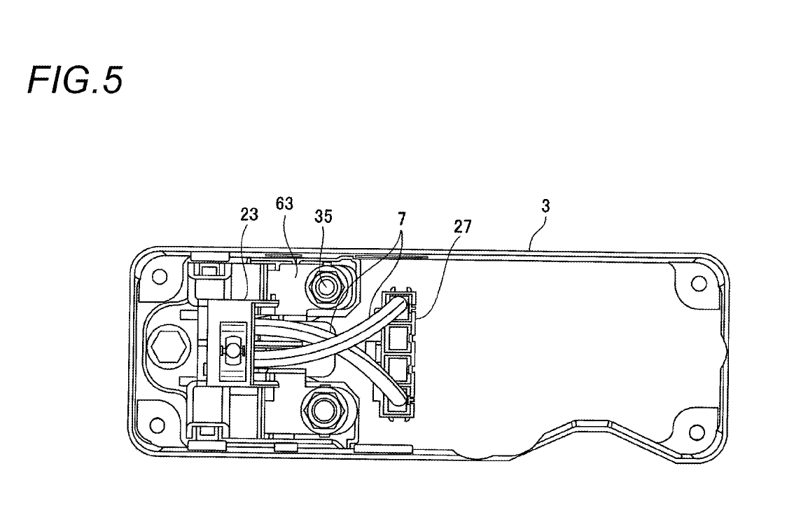

As shown in FIG. 4, among the crimped terminals which are connected to two ends of the pair of electric wires 7, those crimped terminals at one ends (not shown in the figure) are inserted into terminal accommodating rooms 61 of the connector 27, and those crimped terminals 29 at the other ends are attached to and held in the resin block 23. The pair of electric wires 7 are wired to cross each other, as shown in FIG. 5.

The crimped terminals 29a and 29b which are connected to the pair of electric wires 7, respectively, are formed by bending metal plates. Each of these crimped terminals 29 is constructed by including a plate-like conductor 65 which has a terminal part 63 which is connected with the bus bar 19 (part of an external circuit), and a crimped part 67 which is provided at one end of the conductor 65, and which is crimped to a core wire exposed from a terminal part of the electric wires 7, and these crimped terminals 29 are crimped and connected to the electric wires 7 while the electric wires 7 are located at the conductor 65 side of the crimped part 67.

The crimped part 67 is formed by raising a pair of crimped pieces 71 from two side edges of a bottom board 69 to have a U-like section, and are adapted to fasten a core wire of the electric wire 7 which is arranged along the longitudinal direction of the bottom board 69 when the pair of crimped pieces 71 enclose the core wire from two sides. In the present embodiment, an example is shown in which two sets of the pair of crimped pieces 71 are provided along the longitudinal direction of the bottom board 69.

As shown in FIG. 4, the bottom board 69 is formed to follow the conductor 65, but the border of the bottom board 69 and the conductor 65 is provided with a ramp 73 from the bottom plate 69 towards the conductor 65 which is inclined at a predetermined angle to the side opposite to the direction the crimped pieces 71 are raised. That is, since the outer diameter of the core wire of the electric wire 7 is different from that of the coated part of the electric wire 7, when the core wire is arranged along the longitudinal direction of the bottom board 69, the differential part of the outer diameter (thickness) of the coated part is absorbed by the conductor 65 following the ramp 73.

The terminal part 63 includes a flat surface which extends to where the conductor 65 is bent at a roughly right angle, and, in the present embodiment, the terminal part 63 is formed by bending the conductor 65 in a direction opposite to the direction the crimped pieces 71 are raised from the bottom board 69. The terminal part 63, as described later, is formed to be insertable into a groove of the resin block 23, and is provided with two holes, namely, a locking hole 75 and a mounting hole 57 into which the projection 35 is inserted.

As to be described later, a locking projection 77 formed in the resin block 23 may be inserted in the locking hole 75.

As shown in FIG. 4, when the conductors 65 of the pair of crimped terminals 29a and 29b constructed in this way are arranged roughly in parallel with each other, the crimped plate 71 of one terminal extends towards the inner side of the terminals (the other terminal side), and the terminal part 63 of one terminal extends towards the outer side of the terminals (the side opposite to the other terminal side).

The resin block 23 is provided with grooves 79 into which the terminal parts 63 of the crimped terminals 29 are inserted, respectively, at two sides holding the terminal accommodating room 41. Inside the grooves 79, locking arms (not shown in the figure) of a cantilever shape, which elastically deform in a direction perpendicular to the direction the terminal parts 63 are inserted, are provided, and the locking arms are provided with the locking projections 77 on the surfaces facing the terminal parts 63 which are inserted into the grooves 79.

With such a construction, the terminal parts 63 of the crimped terminals 29, which are crimped and connected to the electric wires 7, are inserted into the grooves 79 of the resin block 23. Then, the terminal parts 63 make the locking arms to be elastically deformed to ride on the locking projections 77, and when the distal ends of the terminal parts 63 get over the locking projections 77, the locking arms are restored and the locking projections 77 are inserted into the locking holes 75 of the terminal parts 63. Thereby, the locking projections 77 are locked in the locking holes 75, and the crimped terminals 29 are connected to and held in the resin block 23.

The crimped parts 67 of the pair of crimped terminals 29 connected to the resin block 23 are accommodated in the terminal accommodating room 41 of the resin block 23, respectively, and parts of the pair of crimped terminals 29 including the mounting holes 57 of the terminal parts 63 protrude from the resin block 23. When the resin block 23 is attached onto the terminal block 21 in the case 3, the projections 35 are inserted into the mounting holes 57 of the terminal parts 63, and the electric wires 7 and the bus bars 19 are electrically connected.

According to the present embodiment, because the terminal parts 63 of the crimped terminals 29 (in particular, the mounting holes 57 into which the projections 35 are inserted) can be located to the rear of the electric wires 7 relative to the terminals of the electric wires 7 (the connector 27 side), even if the electric wires 7 are connected at a site whose distance from the connector 27 is relatively small, it is possible to wire the electric wires 7 without forcibly curving the electric wires 7 but in a state of prolonging to some extent, or reducing the curving (curvature) of the electric wires 7. Thereby, because the attaching operation can be performed by reducing the reaction force of the electric wires 7 which occurs when the electric wires 7 are curved, a burden on the operation of attaching the electric wires 7 can be alleviated. Because the space in which the electric wires 7 are handled becomes small if the curving of the electric wires 7 becomes small, the design flexibility in component arrangement, electric wire courses in the case 3 or the like can be raised. According to the present embodiment, because the load applied on the connecting portions at the two ends of the electric wires 7 (including the connecting portions of the electric wires 7 and the crimped terminals) can be lowered, the electrically connected state of the electric wires 7 can be stabilized.

Since generally the reaction force of the electric wires 7 when being curved increases as the full length of the electric wires 7 becomes large, traditionally, a method to cope this situation is considered in which when the distance between the components to be connected is short, the electric wires 7 are curved by increasing the extra length of the electric wires 7 daringly. But with the crimped terminals 29 of the present embodiment, an effect of inhibiting the curving of the electric wires 7 regardless of the length of the electric wires 7 is obtained, the full length of the electric wires 7 can be shortened, and the cost of the electric wires 7 can be reduced.

In addition, according to the present embodiment, because the pair of electric wires 7 are wired to cross each other, without adding an excessive force to the electric wires 7, the electric wires 7 can be gathered up by being bundled up with bundling bands. Thereby, the space where the electric wires 7 are handled can be further reduced, and the design flexibility in the case 3 can be further raised.

According to the present embodiment, because the electric wires 7 are wired to be crossed at the inner side between the pair of crimped terminals 29, a gap that increases in accordance with the distance from the crimped parts 67 is formed between the electric wires 7 and the conductors 65 of the crimped terminals 29 connected to the electric wires 7. Therefore, because the area where the electric wires 7 and the crimped terminals 29 contact can be lowered, the wornness of the electric wires 7 due to the vibration when the electric wires 7 contact with the conductors 65 can be inhibited.

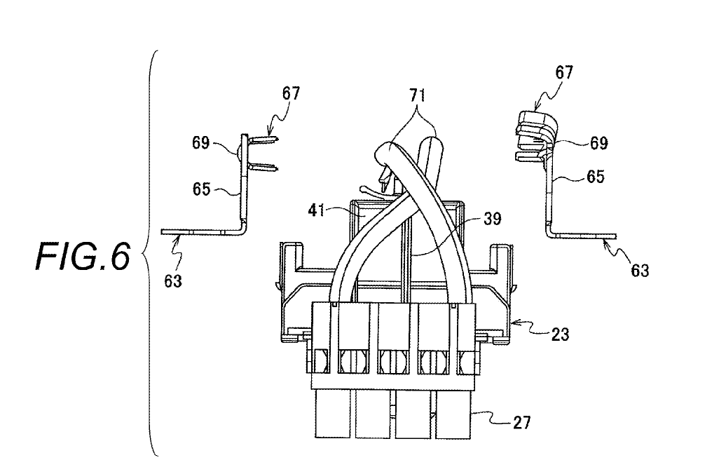

The pair of crimped terminals 29 can be assumed to have shapes that are right-left symmetric to each other, but, as shown in FIG. 6, it is also possible that the wiring angles of the electric wires 7 which are crimped and connected with the crimped parts 67 are formed to be different from each other. That is, the pair of crimped terminals 29a and 29b are formed so that angles that imaginary axes of the electric wires 7 which are crimped and connected to the crimped parts 67 make with imaginary planes including the terminal parts 63 are different from each other.

Thereby, because the contact of the electric wires 7 when the electric wires 7 cross can be prevented, the space where the electric wires 7 are handled can be further reduced, and because the load applied on the two ends of the electric wires 7 can be lowered, the connected state of the electric wires 7 can be stably maintained.

In the present embodiment, by attaching the cover member 25 to the resin block 23, the crimped terminals 29 which are connected to and held in the resin block 23 can be covered by the cover member 25. Therefore, with a simple and compact construction, a short circuit of the conductors including the crimped terminals 29 and the inner wall surfaces of the cover 3 can be prevented. Furthermore, since by covering the resin block 23 with the cover member 25, a situation that a foreign object invades into the conductor portions such as the bus bars 19 can be prevented, the electrically connected state can be maintained well.

The embodiment of the present disclosure is described above in detail with reference to the figures, but the above embodiment is only an illustration of the present disclosure, and the present disclosure is not limited to the constructions of the above embodiment. It is apparent that those modifications in design or the like in a range of not departing from the subject matter of the present disclosure are included in the present disclosure.

For example, in the present embodiment, an example is described in which the connector 27 and the resin block 23 are connected by using the electric wires 7 connected to the power supply side, but the present disclosure is not limited to this, and can be applied to the wiring of all electric wires which, for example, are accommodated in a case.

According to the present disclosure, while the burden in the operation of attaching the electric wires is reduced, the design flexibility can be raised by reducing the space where the electric wires are handled.

What is claimed is:

1. An electric wire connecting structure comprising:
a connector;
a pair of electrical wires, one ends of which are connected to the connector;
a pair of crimped terminals that are respectively connected to the other ends of the pair of electric wires; and
a resin block to which the pair of crimped terminals are attached in a state that the pair of electric wires are curved,
wherein each of the pair of crimped terminals including:
a terminal part to which an external circuit is connected;
a crimped part to which a core wire of the electric wire is crimped; and
a conductor that connects the terminal part and the crimped part, the conductor being located between the terminal part and the crimped part;
wherein the crimped part is configured to crimp the core wire of the electric wire and the electric wire is extended toward the conductor; and
wherein the pair of electric wires are wired in a crossed state between the connector and the pair of crimped terminals.

2. The electric wire connecting structure according to claim 1, wherein the pair of electric wires are wired in a space between the pair of crimped terminals.

3. The electric wire connecting structure according to claim 1, wherein in each of the pair of crimped terminals, the terminal part is bent in a direction substantially perpendicular to an extending direction of the conductor; and
wherein the pair of crimped terminals are so formed that angles that imaginary axes of the electric wires which are crimped to the crimped parts make with imaginary planes including the terminal parts are different from each other.

4. An electrical junction box for connecting a power supply and a load, comprising:
a terminal block that holds a bus bar to which a pair of electric wires connected to the power supply and an electric wire connected to the load are commonly connected;
a resin block that is attached onto the terminal block; and
a conductive case that accommodates the terminal block,
wherein one ends of the pair of electric wires connected to the power supply are connected to a connector arranged at a bottom part of the conductive case, and the other ends of the pair of electric wires connected to the power supply are held in the resin block through the pair of crimped terminals;
wherein each of the pair of crimped terminals including:
a terminal part to which an external circuit is connected;
a crimped part to which a core wire of the electric wire is crimped; and
a conductor that connects the terminal part and the crimped part, the conductor being located between the terminal part and the crimped part;
wherein the crimped part is configured to crimp the core wire of the electric wire and the electric wire is extended toward the conductor;
wherein the resin block is so formed that when the resin block is attached onto the terminal block, the terminal parts of the pair of crimped terminals are arranged at positions where the terminal parts are connected to the bus bar; and
wherein the pair of electric wires are wired in a crossed state between the connector and the pair of crimped terminals.

5. The electrical junction box according to claim 4, wherein the resin block has accommodating rooms which accommodate the crimped parts of the pair of crimped terminals respectively.

6. The electrical junction box according to claim 4, wherein an insulative cover member which surrounds the pair of crimped terminals held in the resin block is attached to the resin block.
